(19) United States
(12) Patent Application Publication
(10) Pub. No.: US 2008/0239599 A1
(43) Pub. Date: Oct. 2, 2008

(54) Clamping Voltage Events Such As ESD

(76) Inventors: Yehuda Yizraeli, Nofit (IL); Yoram Betser, Mazkeret Batya (IL); Ilan Bloom, Haifa (IL)

Correspondence Address: EMPK & Shiloh, LLP, 116 JOHN ST,, SUITE 1201, NEW YORK, NY, 10038, US

(21) Appl. No.: 11/695,029

(22) Filed: Apr. 1, 2007

(51) Int. Cl. H02H 9/00

(52) U.S. Cl. 361/56

(57) ABSTRACT

A clamping scheme using dual sensing detection, which can sense and differentiate (in the extreme) between a high voltage level and fast (enough) slope (indicative of ESD), and low voltage level and slow slope (indicative of normal operation) and/or low voltage level and fast slope (indicative of hot insertion). It can also generate a locking scheme to ensure proper discharging only if the level is above high level and fast slope. It can also operate the clamping for a short time only if the level is below the high level but above the low level, and of sufficient slope.

### TECHNICAL FIELD

This disclosure relates to integrated circuit (IC) chips, more particularly to protecting circuitry of chips' power supplies and I/O pads and more particularly to protecting the functional elements of an IC chip from electrostatic discharge (ESD).

### BACKGROUND

Electrostatic discharge (ESD) may be described as the sudden and momentary electric current that flows when an excess of electric charge, stored on an electrically insulated object, finds a path to an object at a different electrical potential (such as ground). The term is usually used in the electronics and other industries to describe momentary unwanted currents that may cause damage to electronic equipment.

ESD is a serious issue in solid-state electronics. Integrated circuits are made from semiconductor materials such as silicon and insulating materials such as silicon dioxide. Either of these materials can suffer permanent damage when subjected to high voltages. Manufacturers and users of integrated circuits must take precautions to avoid this problem. Such measures include special design techniques for device input, output pins and supply pins, using appropriate ESD safe packing material, the use of conductive tracks on cleanroom clothing worn by assembly workers, conducting wrist straps and foot-straps to prevent high voltages from accumulating on workers' bodies, anti-static mats or conductive flooring materials to conduct harmful electric charges away from the work area, and humidity control because, in humid conditions, the surface layer of moisture on many objects conducts electric charges harmlessly to earth.

For testing the susceptibility of electronic devices to ESD from human contact, a simple test circuit called the human body model (HBM) is often used. This consists of a capacitor in series with a resistor. The capacitor is charged to a specified high voltage from an external source, and then suddenly discharged through the resistor into an electrical terminal of the device under test. One of the most widely used models is defined in the JEDEC 22-A114-B standard, which specifies a 100 pf (picofarad) capacitor and a 1500 ohm resistor. Other similar standards are MIL-STD-883 Method 3015, and the ESD Association's ESD STM5.1. These standards are incorporated by reference in their entirety herein,

Other standardized ESD test circuits include the following:

Machine model (MM)

Charged device model (CDM)

Socketed Device Model (SDM)

Transmission line pulse (TLP)

All these ESD testing standards define the testing method and procedure as well as the test circuit.

For qualification testing of semiconductor devices, ESD and latchup are commonly considered together. “Latchup” is the inadvertent creation of a low-impedance path between the power supply rails of an electronic component, triggering a parasitic device, which then acts as a short circuit, leading to cessation of proper function of the part and perhaps even its destruction with the overcurrent. A power cycle is typically required to correct the situation.

Electrostatic discharge (ESD) has been the main reliability concern in semiconductor devices, especially in the scaled-down CMOS technologies. Due to the low breakdown voltage of the thinner gate oxide in deep-submicron CMOS technologies, an efficient on-chip ESD protection circuit should be designed to clamp the overstress voltage across the gate oxide of the internal circuits.

As a whole chip ESD protection is needed, an ESD scheme to protect the whole chip is required. FIG. 1 shows a general (prior art) example of ESD protection scheme. Electro Static Discharge circuitry (such as diodes, snapback devices, SCRs) is typically connected between each input and/or output pad to the supply rails. Part of the discharge path is through the main supply rails. For this, a clamping circuitry (referred to herein as a “clamper circuit” and/or a “clamper”), is used, discharging the higher supply rail to the lower supply rail, and by that not allowing for a potential higher than a pre-defined one, to be built between the two rails (which is the clamping operation). This is a must for protecting all circuitry (typically Low Voltage) inside the chip. For cases where the lower supply rail is raised above the higher supply rail (a case that can typically happen during ESD event and not during normal operation) a diode is connected between the two rails, acting as a clamping circuitry, in a way which will act as a discharge path, in other words the anode is connected to the lower supply rail, and the cathode is connected to the higher supply rail. Such ESD protection design can provide high ESD protection level for the digital input, output pins and digital internal logic.

A more complete description of NROM and similar ONO cells and devices, as well as processes for their development may be found at “Non Volatile Memory Technology”, 2005 published by Saifun Semiconductors Ltd. and materials presented at and through http://siliconnexus.com, both incorporated by reference herein in their entirety.

### Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. Some of the terms set forth below may be registered trademarks (®).
Amplifier A circuit or element that provides gain. There are various types of amplifiers, such as:
   Comparison: An amplifier which compares one signal to a stable reference, and amplifies the difference to regulate the power supply power-control elements.
   Direct Coupled (dc): An amplifier that can provide gain for zero-frequency signals.
   Differential: An amplifier which has available both an inverting and a non-inverting input, and which amplifies the difference between the two inputs.
   Error Amplifier: An operational amplifier, or differential amplifier, in a control loop that produces an error signal whenever a sensed output differs from a reference voltage.
   Inverting: An amplifier whose output is 180 degrees out of phase with its input. Such an amplifier can be used with degenerative feedback for stabilization purposes.
   Non-inverting: An amplifier, the output of which, is in phase with its input
   Operational: A dc amplifier whose gain is sufficiently large that its characteristics and behaviour are substantially determined by its input and feedback elements. Operational amplifiers are widely used for signal processing and computational work.
Cell Well (CW) the cell well is an area in the silicon substrate that is prepared for functioning as a transistor or memory cell device by doping with an electron acceptor material such as boron or indium (p, electron acceptors or holes) or with an electron donor material such as phosphorous or arsenic (n, electron donors). The depth of a cell well is defined by the depth of the dopant distribution.
Clamp circuit A clamp circuit is a circuit that clamps high voltage when reaching a predefined level/levels. Also referred to as “clamper”.
CMOS short for complementary metal oxide semiconductor. CMOS consists of n-channel and p-channel MOS transistors. Due to very low power consumption and dissipation as well minimization of the current in “off” state CMOS is a very effective device configuration for implementation of digital functions, CMOS is a key device in state-of-the-art silicon microelectronics.
   CMOS Inverter. A pair of two complementary transistors (a p-channel and an n-channel) with the source of the n-channel transistor connected to the drain of the p-channel one and the gates connected to each other. The output (drain of the p-channel transistor) is high whenever the input (gate) is low and the other way round. The CMOS inverter is the basic building block of CMOS digital circuits.
   NMOS: n-channel CMOS. (also nMOS)
      ggnMOS: gate-grounded nMOS
   PMOS: p-channel CMOS.
Diode A two-terminal device having a cathode and an anode that permits current to flow in one direction and blocks flow in the other direction.
Dopant element introduced into semiconductor to establish either p-type (acceptors) or n-type (donors) conductivity; common dopants in silicon: p-type, boron, B, Indium, In; n-type phosphorous, P, arsenic, As, antimony, Sb.
Electronic Components In the description(s) set forth herein, various conventional electronic components may be referred to, including:
Capacitor A capacitor is a device that stores energy in the electric field created between a pair of conductors on which equal but opposite electric charges have been placed. A capacitor is occasionally referred to using the older term condenser. A capacitor typically has two terminals.
   Diode: a diode is a component that restricts the direction of movement of charge carriers. It allows an electric current to flow in one direction, but essentially blocks it in the opposite direction. Thus the diode can be thought of as an electronic version of a check valve. Most modern diodes are based on semiconductor p-n junctions. In a p-n diode, conventional current can flow from the p-type side (the anode) to the n-type side (the cathode), but not in the opposite direction. Another type of semiconductor diode, the Schottky diode, is formed from the contact between a metal and a semiconductor rather than by a p-n junction. Zener diodes can be made to conduct backwards. This effect, called Zener breakdown, occurs at a precisely defined voltage, allowing the diode to be used as a precision voltage references. A diode typically has two terminals, some have three.
   Resistor: A resistor is a two-terminal electrical or electronic component that resists the flow of current, producing a voltage drop between its terminals in accordance with Ohm's law (E=IR, or I equals E over R). The electrical resistance is equal to the voltage drop across the resistor divided by the current that is flowing through the resistor. Resistors are used as part of electrical networks and electronic circuits. A resistor typically has two terminals.
   Transistor: The transistor is a solid state semiconductor device which can be used for amplification, switching, voltage stabilization, signal modulation and many other functions. It acts as a variable valve which, based on its input voltage, controls the current it draws from a connected voltage source. Transistors are made either as separate components or as part of an integrated circuit. A good analogy for explaining the transistor is like a water tap (faucet). The water tap knob controls the flow of the water. In transistors the control tap is called the Base in BJT (Bipolar Junction Transistor), or Gate in FET (Field Effect Transistor) or IGBT (Insulated Gate Bipolar Transistor). Transistors control the flow of electronic current. A transistor typically has three terminals.
FET short for field effect transistor. The FET is a transistor that relies on an electric field to control the shape and hence the conductivity of a “channel” in a semiconductor material. FETs are sometimes used as voltage-controlled resistors. The terminals of FETs are called gate, drain and source.
Flash memory Flash memory is a form of non-volatile memory (EEPROM) that can be electrically erased and reprogrammed. Flash memory architecture allows multiple memory locations to be erased or written in one programming operation.
Logic Gates A logic gate performs a logical operation on one or more logic inputs and produces a single logic output. The logic normally performed is Boolean logic and is most commonly found in digital circuits. Logic gates are primarily implemented electronically using diodes or transistors. NAND and NOR logic gates are the two pillars of logic, in that all other types of Boolean logic gates (such as AND, OR, NOT, XOR, XNOR) can be created from a suitable network of just NAND or just NOR gate(s). A logic gate takes one or more logic-level inputs (such as logic states of “1” and “0”) and produces a single logic-level output. Because the output is also a logic level, an output of one logic gate can be connected to the input of one or more other logic gates. Some exemplary logic gates having two inputs and an output operate, as follows:
   OR: A logic state of “0” on both inputs results in an output of “0”. A logic state of “1” on either or both of the inputs results in an output of “1”.
   NOR: A logic state of “0” on both inputs results in an output of “1”. A logic state of “1” on either or both of the inputs results in an output of “0”.
   AND: A logic state of “0” on both inputs results in an output of “0”. A logic state of “1” on both inputs results in an output of “1”. A logic state of “0” on one input and a logic state of “1” on the other input results in an output of “0”.
NAND: A logic state of “0” on both inputs results in an output of “1”. A logic state of “1” on both inputs results in an output of “0”. A logic state of “0” on one input and a logic state of “1” on the other input results in an output of “1”.
MOSFET short for metal oxide semiconductor field-effect transistor. MOSFET is by far the most common field-effect transistor in both digital and analog circuits. The MOSFET is composed of a channel of n-type or p-type semiconductor material, and is accordingly called an NMOSFET or a PMOSFET. (The ‘metal’ in the name is an anachronism from early chips where gates were metal; modern chips use polysilicon gates, but are still called MOSFETs).
n-type semiconductor in which concentration of electrons is higher than the concentration of “holes”. See p-type.
NROM short for nitride read only memory.
SCR short for silicon controlled rectifier. An SCR is a 4-layer solid state device that controls current flow. An SCR can be seen as a conventional rectifier controlled by a gate signal. It is a 3-terminal device.
Voltage abbreviated v, or V. A voltage can be positive or negative (or zero) Usually, a negative voltage is preceeded by a minus sign (−). Sometimes a positive voltage is preceeded by a plus sign (+), or no sign at all. A number of voltages are relevant with regard to operating a memory cell, and are typically designated by the capital letter “V”, followed by another letter or letters. Some exemplary voltages of interest are are:

| | |
|---|---|
| Vt | short for threshold voltage |
| Vs | short for source voltage |
| Vd | short for drain voltage |
| Vg | short for gate voltage |
| Vds | the potential difference between source and drain (or drain and |
| | source) |
| Vb | short for bulk (or substrate) voltage. sometimes written Vsub |
| Vbi | short for built-in potential (bit line to substrate) |
| Vbl | short for bitline voltage. (the bitline may function as source or |
| | drain) |
| Vwl | short for wordline voltage (which typically is the same as Vg) |
| VDDH | short for higher voltage supply pin. |
| Vdd | short for lower voltage supply pin. |
| Vccq | short for I/O Circuitry supply pin. |
| Vccq | in short for Input buffer supply pin. |
| Vss | short for substrate voltage |

### BRIEF DESCRIPTION (SUMMARY)

According to the disclosure, a clamping scheme uses dual sensing detection, which can sense and differentiate (in the extreme) between a high voltage level and fast (enough) slope (indicative of ESD), and low voltage level and slow slope (indicative of normal operation) and/or low voltage level and fast slope (indicative of hot insertion). It can also generate a locking scheme to ensure proper discharging only if the level is above high level and fast slope. It can also operate the clamping for a short time only if the level is below the high level but above the low level, and of sufficient (above a threshold, pre-determined) slope.

According to the disclosure, a method of performing voltage clamping comprises: determining whether a voltage is above a pre-defined level; and sensing voltage slope for voltages, which are above the pre-defined level. Voltage events may be clamped when the voltage slope exceeds the pre-defined level, and voltage events, which are below the pre-defined level, may be ignored.

According to the disclosure, a clamper comprises: means for determining whether a voltage is above a pre-defined level; means for sensing voltage slope for voltage events which are above the pre-defined level; and means for discharging voltage events which are above the predefined level. A voltage event, which is a spike, may be discharged until the pre-defined level is reached. A voltage event, which is an ESD may be discharged completely.

### BRIEF DESCRIPTION OF THE DRAWINGS

Reference will be made in detail to embodiments of the disclosure, examples of which may be illustrated in the accompanying drawing figures (FIGs). The figures are intended to be illustrative, not limiting. Although the disclosure is generally described in the context of these embodiments, it should be understood that it is not intended to limit the disclosure to these particular embodiments.

Conventional electronic components may be labeled with conventional schematic-style references comprising a letter (for example, A, C, Q, R, D) indicating the type of electronic component (for example, amplifier, capacitor, transistor, resistor, diode, respectively) followed by a number indicating the iteration of that element (for example, “1” meaning a first of typically several of a given type of electronic component). Components such as resistors and capacitors typically have two terminals, which may be referred to herein as “ends”. In some instances, “signals” are referred to, and reference numerals may point to lines that carry said signals In the schematic diagrams, the various electronic components are connected to one another, as shown.

In schematic diagrams illustrating a “flow”, the direction is usually from left-to-right. However, it can also be, without limitation, from right-to-left.

Elements of the figures may (or may not) be numbered as follows. The most significant digits (hundreds) of the reference number correspond to the figure number. For example, elements of FIG. 1 are typically numbered in the range of 100-199, and elements of FIG. 2 are typically numbered in the range of 200-299. Similar elements throughout the figures may be referred to by similar reference numerals. For example, the element 199 in FIG. 1 may be similar (and possibly identical) to the element 299 in FIG. 2. Throughout the figures, each of a plurality of elements 199 may be referred to individually as 199a, 199b, 199c, etc. Such relationships, if any, between similar elements in the same or different figures will become apparent throughout the specification, including, if applicable, in the claims and abstract.

Regarding the use of subscripts (in the drawings, as well as throughout the text of this document), sometimes a character (letter or numeral) is written as a subscript—smaller, and lower than the character (typically a letter) preceding it, such as “Vₛ” (source voltage) or “H₂O” (water). For consistency of font size, such acronyms may be written in regular font, without subscripting, using uppercase and lowercase—for example “Vs” and “H2O”.

FIG. 1 is a schematic diagram of an ESD protection scheme, according to the prior art.

FIG. 2 is a schematic diagram of the conventional, RC based, clamper according to the prior art.

FIG. 3A is a schematic diagram of a dual voltage ESD protection concept, according to prior art, which will be used for description purposes in this disclosure.

FIG. 3B illustrates input to output ESD event (both positive and negative) according to the ESD scheme shown in FIG. 3A.

FIG. 3C illustrates output to power supply ESD event (both positive and negative) according to the ESD scheme shown in FIG. 3A.

FIG. 4A is a schematic diagram of an embodiment of a clamper circuit, according to the disclosure.

FIG. 4B is a more detailed schematic diagram of an embodiment clamper circuit, according to the disclosure, where the two level detectors are shown.

FIG. 5 is a diagram showing the three regions of operations of the dual-level sensing clamper: a. low region: normal operation—no clamping, b. medium region: Suspected ESD event or high voltage supply case—clamper operates but no locking. C. high region: ESD event—clamper operates and locking activation put the VDET1_trip and VDET2_trip marks on the lower axis.

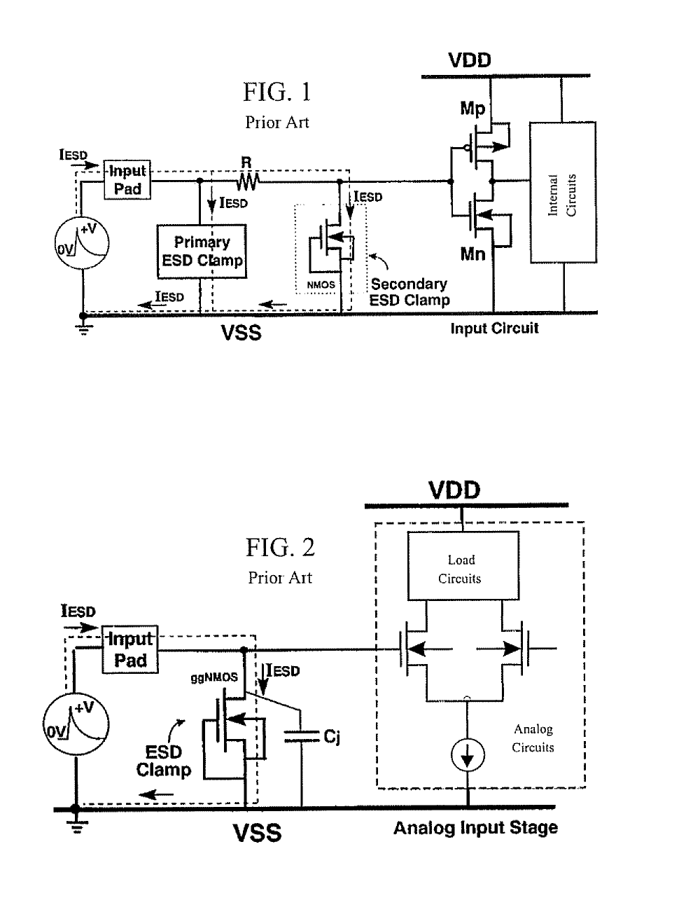

### DETAILED DESCRIPTION

The disclosure is generally directed to a clamper, which may be part of an overall ESD (Electro-Static Discharge) and chip power scheme. The clamper should be integrated into the chip without adversely affecting its behaviour or operation condition. The clamper should clamp ESD events as described in ESD Specs (specifications) the chip should comply to.

The clamper is supposed to clamp any ESD event. ESD Events are destructive, thus fast response is required for power/heat dispersing, else the chip can be damaged and rendered non-functional. However, the chip should function within its operation specification without any interference from the ESD clamper. Fast supply rise time (ramp) is part of the chips' specification, especially, but not limited to, Memory Card Applications, where the card can be inserted into a system already powered on. In order to be effective, the clamper should differentiate between fast ESD voltage ramp and fast supply ramp—it should clamp the fast ESD voltage ramp while not interfering with the fast supply ramp. Supply noise is (limited in amplitude) part of the chips' operation environment. This limited noise should not be treated as an ESD event.

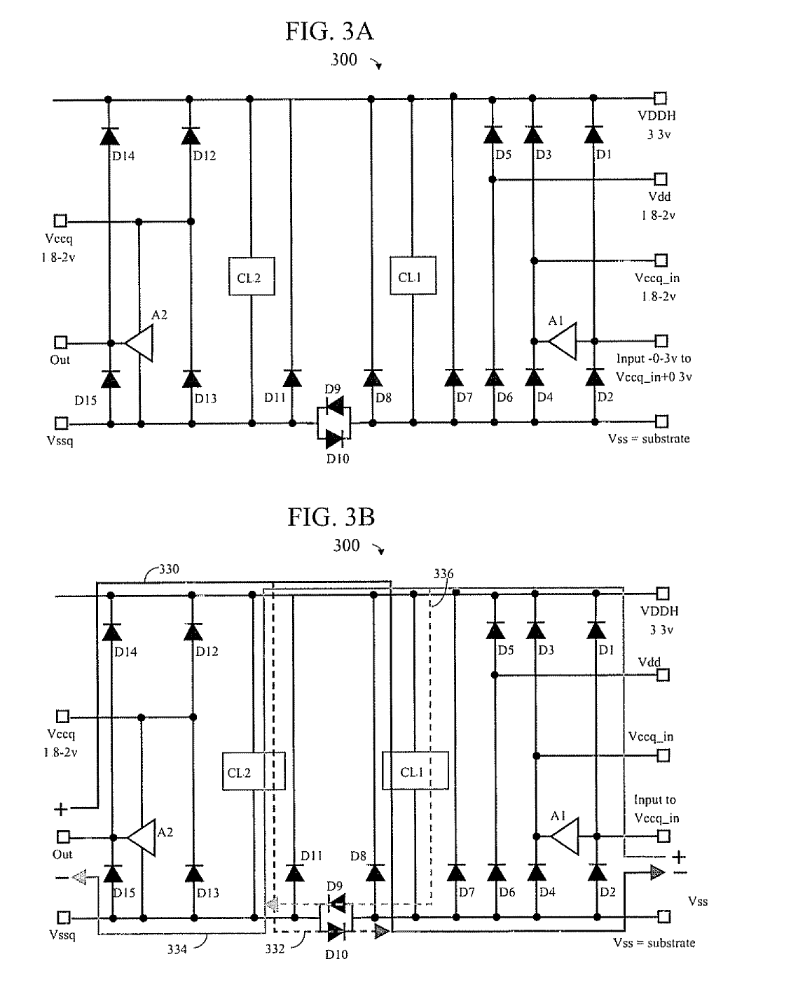

Most prior art clamper designs are based on a simple RC (resistor-capacitor) network as shown in FIG. 2, which can easily distinguish between a fast ESD voltage ramp and a typically slow power supply ramp. These RC based designs, does not distinguish between low and high levels. In fact the prior art circuitry distinguish between fast and slow supply ramp only. This is why the prior art designs cannot support hot-insertion modes as described in the following paragraph. Designs with prior-art ESD clampers does not support hot-insertion or solve this issue on application level.

A situation addressed by this disclosure, involving fast supply ramp, is typified by (and somewhat unique to) Memory Card Applications that require hot insertion (plugging a memory module into an apparatus which is turned on), resulting in a fast supply ramp. Generally, a fast ramp, from zero up to supply voltage, will not damage the memory card.

Generally, the technique disclosed herein solves the problem by using a double sensing scheme. Typically, ESD events will be of much higher voltage than supply voltages or supply noise voltage during normal operation.

First, by sensing the voltage level, only voltage levels above pre-defined levels are treated as a candidate ESD event. This allows fast supply ramps to be “filtered” (ignored), thereby not responding to them (ignoring them). As used herein, supply levels include all voltages within normal operating range, as well as voltages used for burn-in conditions. (Burn-in typically uses voltages somewhat higher than normal operating voltages, in conjunction with elevated temperature.)

Second, in addition to only responding to voltage events above a pre-defined level, the double sensing mechanism differentiates between, and reacts differently to, voltage events which are (i) ESD events and voltage events which are (ii) normal operation of the chip.

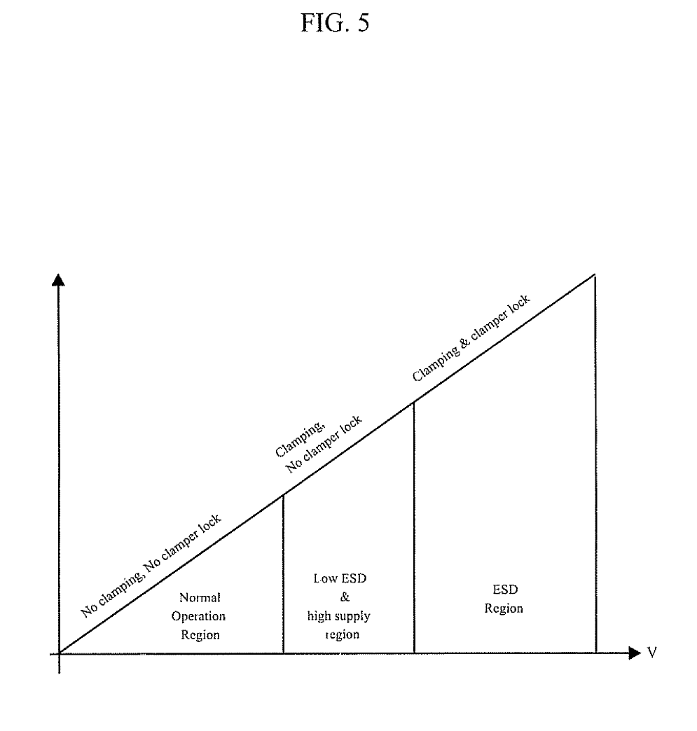

To achieve the objectives of differentiation between the ESD events and normal operation, the double sensing scheme is used. The following description refers to FIG. 5.

All events with voltage amplitudes lower than the first detection level, VDET1₁₃ trip are treated as normal operation. Like the prior art detectors, in this voltage range no clamping occurs and the clamper does not affect chip's normal operation.

All events with voltages above the second detection level, VDET2_trip, are treated as ESD events, which imply that the clamper is activated and a locking circuitry is also activated, keeping the operation of the clamper as long as necessary to completely discharge the ESD event.

Due to process variations, temperature effects and different system designs, there could be an overlap of the 2 cases described above, i.e. a fast ramp which is not an ESD can go higher than the first detection level, VDET1_trip, but is lower than VDET2_trip. In this case, the clamper should be activated, because if it is a ESD event, then delaying it's activation might result in voltages across the chip which are higher than the chip could tolerate. On the other hand, the locking mechanism is not turned on, so that if it is not a ESD event, the power supply is not shorted, and the clamper will only operate for a short while (discharging the extra voltage on the power supply but not more than that). If it was an ESD event, anyway the voltage level would rise above the VDET2_trip and the locking circuitry would be turned on.

Thus, there are three voltage events of concern:
Event 1: supply voltage ramp up. For purposes of this disclosure, a supply voltage ramp up is an increase in voltage from zero (typically, unplugged), to normal operating or burn-in levels (such as up to 5 volts for memory chip applications). The ramp is up to levels that are lower than the first detector level, VDET1_trip.
Event 2: supply voltage ramp, up-to level that are higher than the first detectable level, VDTE1_trip, but lower than the second detectable level, VDET2_trip.
Event 3: An ESD event which involves a voltage higher than the VDET2_trips

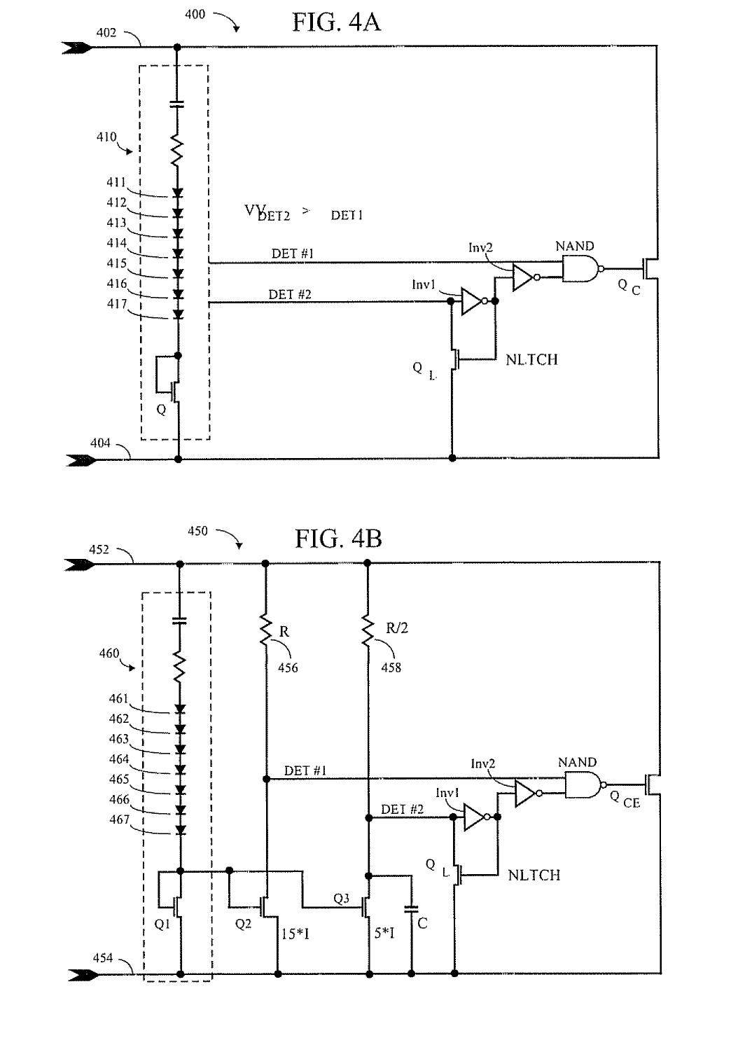

The circuit that is shown (in FIGS. 4A and 4B) and described is an ESD clamper, which means that it clamps voltage that is higher than a predefined level. However, the circuit can be used (with appropriate tuning) for dual-level clamping and/or detection for other purposes. The first level is normal operation level, namely all input voltage up to this voltage level are treated as normal levels and will not be clamped. Input levels above the first predefined level but lower than the second predefined level will be clamped but without permanent lock of the clamper. When reaching the second level, which is defined (in the circuit) by voltage, the clamper locks itself and clamping continues until the high voltage event is over, at which point the clamper resets itself.

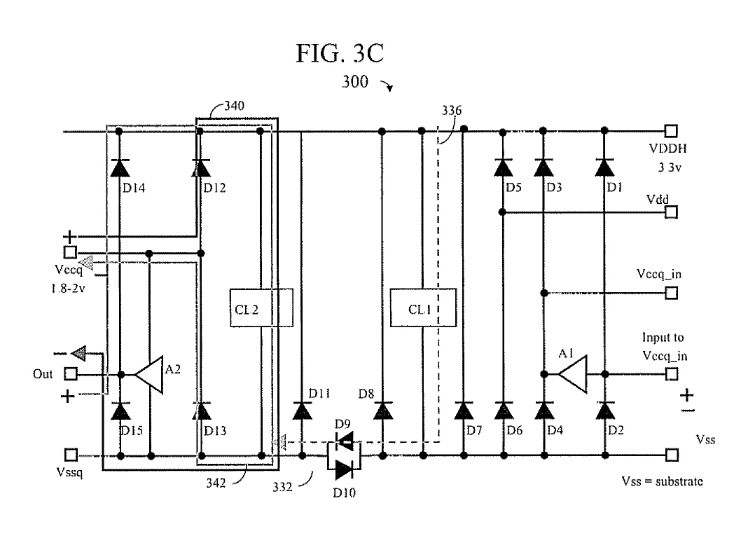

When the clamper is used in an overall ESD scheme, diodes, snapback devices or any other special devices are placed in a way such that they will conduct ESD charge in an ESD event from the pad (input or output or I/O) to the Power supply (e.g. VCC) but will not hurt normal operation mode. More precisely, in normal operation mode, where diodes are used, the anode of the diode is in a lower potential than the cathode of the diode. Note that the diodes shown in the FIGS. 3A, 3B, 3C could be replaced by any other ESD structure (such as snapback devices)—this will not have an effect on the performance of the clamper described here. As shown in FIGS. 3A,B,C. The clamper would be placed in the ESD scheme in a way that the potential of the positive port is always higher than the negative port of the clamper.

FIG. 3A shows an embodiment of an ESD protection concept (circuit), and illustrates an embodiment of connecting the clampers of the present disclosure in an overall ESD protection concept. The figure illustrates an application wherein there are several chip inputs and outputs, many supply voltages—some of which are noisy. Not all supplies are at the same voltage level. The figure illustrates that, in this ESD concept, the voltages must be arranged in order of magnitude—in this example, VDDH is higher than all other supply voltages.

Fifteen diodes D1-D15 are shown, and may be of two types, as follows:
D2,4,6,7,8,9 are constructed as n+ on p-sub (substrate), but could be any other N/P configuration, where the P (in this case) is shorted to the substrate.
D1,3,5,10,11-15 are constructed as p+ on n-well, but could be any P/N configuration as long as the P and/or the N are not shorted to the substrate.

The diodes D1-D15 are laid out to obtain large current capacity, minimal series resistance, no self damage.

The diodes (other than D9 and D10) are connected generally from bottom to top (cathode towards highest voltage rail), so that there will be (under normal operating conditions) no reverse current flow through the diodes (Except for diode leakage).

Two of the diodes (D9 and D10) are shown connected “back-to-back”, in the substrate supply line (Vss), to accommodate a noisy line.

Two clampers CL1 and CL2 are shown. Each clamper has a “high” terminal connected to the highest voltage (VDDH) rail, and a “low” terminal connected to a lowest voltage rail (Vss/Vssq). Note: in large chips there are more than one clamper per supply port. Exemplary clampers are shown in greater detail in FIGS. 4A and 4B.

Two amplifiers A1 and A2 are shown. Amplifier A1 serves as an input buffer while Amplifier A2 serves as an output buffer .

Five inputs are shown, as follows:
VDDH which is approximately 2.6-3.6 volts
Vdd which is approximately 1.8-2.0 volts
Vccq_in which is approximately 1.8-2.0 volts
Input −0.3 v to Vccq_in +0.3 v
Vss, substrate voltage, which is approximately 0 volts
Vccq, I/O Supply, which is approximately 1.8-2.0 volts
Vssq,_I/O Aupply, which is, which is approximately 0 volts

One output is shown, as follows:
Out (I/O), 0V-3.6V

FIG. 3B is schematic diagram of the ESD protection concept of FIG. 3A, illustrating two cases of ESD events:
a. Where the positive ESD port is connected to a I/O pad, and the negative ESD port is connected to an input pad. In this case, diode D14 conducted the ESD current (charge) from the I/O pad to the VDDH power supply line, the clapmers conducted the ESD current from the VDDH supply to the Vss and Vssq supply lines. D2 conducts the current from the Vss supply to the input pad (negative ESD port) and D10 conduted some of the ESD current from the Vssq supply line to the Vss supply line,
b. Where the positive ESD port is connected to an input pad, and the negative ESD port is connected to a I/O pad. In this case, diode D1 conducted the ESD current (charge) from the input pad to the VDDH power supply line, the clapmers conducted the ESD current from the VDDH supply to the Vss and Vssq supply lines. D15 conducted the current from the Vssq supply line to the I/O pad (negative ESD port) and D9 conduted some of the ESD current from the Vss supply line to the Vssq supply line,

The solid line 330, extending from left (+) to right (−), from “Out”, through the clamp CL1, to the Input to Vccq, illustrates the main discharge path.

The dashed line 332, extending from the solid line 330, through the diode D10, and through the clamp CL2, illustrates the secondary/additional discharge path.

The solid line 334, extending from right (+) to left (−), through clamp CL2, illustrates the main discharge path.

The dashed line 336, extending through diode D9, and through clamp CL1, illustrates the secondary/additional discharge path.

FIG. 3C is schematic diagram of the ESD protection concept of FIG. 3A, illustrating 2 cases of ESD events: a. Where the positive ESD port is connected to a I/O pad, and the negative ESD port is connected to I/O supply pad Vccq. In this case, diode D14 conducted the ESD current (charge) from the I/O pad to the VDDH power supply line, the clapmers conducted the ESD current from the VDDH supply to the Vss and Vssq supply lines D13 conducted the current from the Vssq supply to the I/O supply pad Vccq (negative ESD port) and D9 conduted some of the ESD current from the Vss supply line to the Vssq supply line, b. Where the positive ESD port is connected to I/O supply pad Vccq, and the negative ESD port is connected to a I/O pad. In this case, diode D12 conducted the ESD current (charge) from the I/O supply pad V_{CCQ} to the VDDH power supply line, the clapmers conducted the ESD current from the VDDH supply to the Vss and Vssq supply lines D15 conducted the current from the Vssq supply line to the I/O pad (negative ESD port) and D9 conduted some of the ESD current from the Vss supply line to the Vssq supply line.

The solid line 340, extending from left (+) to left (−), through clamp CL2, illustrates the main discharge path

The dashed line 336, extending through diode D9, and through clamp CL1, illustrates the secondary/additional discharge path

FIGS. 4A and 4B show block diagrams of the clamper, according to the disclosure. In both figures, the top horizontal line is the high (+) rail (such as VDDH from FIG. 3A), and the bottom horizontal line is the low (−) rail (such as Vss or Vssq from FIG. 3A). The rails may be referred to as “ports”.

In FIG. 4A, the clamper 400 is connected between the high rail 402 and the low rail 404. A detector 410 in the clamper 400 detects voltage rise occuring on the clamper's ports. The clamper 400 (in this example) is diode based, although other elements (such as transistor diodes and in some cases resistors), that provide the necessary diffrentation between voltage levels can be used, comprising a string of 7 diodes 411-417, connected in series with one another and having their cathodes oriented towards the low rail (generally, opposite to the diodes in FIG. 3A). The number of diodes (in this example, 7), defines the detection voltage, based on the number of diodes times the actual forward voltage on each diode. Practically, all of the diodes 411-417 should be the same as one another, although this is not necessary for the operation of the clamper.

The string of diodes is connected via a resistor and series-connected capacitor to the high rail (positive port) 402. The purpose of the resistor is to define the current through the diodes and limit it while the circuit is active and the purpose of the capacitor is to limit the time this circuit is active. This is mostly impotant for eliminating standby current. The time constant should be, of course, sufficient for detection and discharging events, in the second region (see FIG. 5) which are not causing the clamper to lock itself, and is similar in principle to the RC time constant concept of the prior art.

The string of diodes is connected via a transistor Q1 to the low rail (negative port) 404. The purpose of the transistor Q1 (FIG. 4B) is to be the main current miror reference transistor, that is to provide the transistors Q2 and Q3 gate bias such that will determine the necessary current flowing in these transistors. The current of transistor Q2 and transistor Q3 is a multiplication of transistor Q1.

The detector 410 has two outputs—a lower threshold output DET1, and a higher threshold output DET2. Both DET1 and DET2 voltages are close to the higher rail 452 when no current is flowing in Q2, Q3. When 452 rail rise (e.g., due to ESD event) to a sufficient level, DET1 will be pulled by Q2 towrds the lower rail 454, and if the volatge of DET1 is below the trip-point (“threshold”) of the NAND gate, the output of the NAND gate will change logical state from logical ‘0’ to logical ‘1’. For even a higher level of the supply rail 452, DET2 will be pulled to the lower rail 454 by Q3, and if the volatge of DET2 is below the trip-point (“threshold”) of the INVERTER gate (Inv1), the output of the INVERTER (“NLTCH”) gate will change logical state from logical ‘0’ to logical ‘1’. Always, DET1 will be pulled towards the lower rail 452 before DET2, such that, always, the NAND output will change logical state, before the INVERTER output does so. The potential difference between rail 452 and rail 454, which cause DET1 to change logical value from ‘1’ to ‘0’, is refered to as VDET1_trip, as shown in FIG. 5, and the potential difference between rail 452 and rail 454, which cause DET2 to change logical value from ‘1’ to ‘0’, is refered to as VDET2_trip, as shown in FIG. 5. In this case, VDET2_trip>VDET1_trip.

As described above, the lower threshold output DET1 is supplied to an input of a NAND gate, and performs the task of establishing the pre-defined level above which voltage events such as ESD are detected, as described hereinabove. If the voltage is below the VDET1_trip level, the situation is indicative of normal operation (including burn-in) and no clamping, neither locking will occur.

One input of the NAND logic gate is driven directly by DET1 signal. The other input of the NAND logic gate is driven by DET2 signal, via a first inverter Inv1 followed by a second inverter Inv2. A transistor QL is connected to the bottom rail (negative port) 404 and across the first inverter, as shown in FIG. 4A. Transistor QL is the locking transistor. Once the first inverter's gate (Inv1 in FIG. 4A) is driven low (by DET2 signal), its output is togeling to logical ‘1’, the gate of transistor (QL) is driven high, thus puling the input of the inverter (Inv1 in FIG. 4A) low. The ESD event is locked. This locking force DET2 node to be at logical ‘0’, holding the gate of the first inverter (Inv1 in FIG. 4A) low regardless of the voltage across the clamper's ports. The output of the NAND gate drives a clamping element, transistor Qce, which is capable of discharging very high currents, as necessary according to the ESD protection specification.

FIG. 4B illustrates another, more detailed embodiment of a clamper 450 (compare 400). The clamper 450 is connected between the high rail 452 (compare 402) and the low rail 454 (compare 404), and has all of the elements recited above with respect to the clamper 400.

As before (clamper 400), a detector 410 in the clamper 450 detects voltage rise occuring on the clamper's ports.

As before (clamper 400), the clamper 450 is diode based, comprising a string of 7 diodes 461-467, connected in series with one another and having their cathodes oriented towards the low rail (generally, opposite to the diodes in FIG. 3A).

As before (clamper 400), the string of diodes is connected via a resistor and series-connected capacitor to the high rail (positive port) 452.

As before (clamper 400), the string of diodes is connected via a transistor Q1 (compare Q) to the low rail (negative port) 404.

In this embodiment, a current-mirroring scheme is employed. This involves the transistor Q1 establishing the current to be mirrored, and the current-mirroring transistors Q2 and Q3.

Generally, in current-mirroring, a first transistor (in this case Q1) is connected such that it has a given current flowing through it and behaves as a forward-biased diode. If the first transistor is connected to a fixed voltage source, the current flowing through the first transistor will also be fixed, or constant. If the first transistor is connected to a varying voltage source, the current flowing through the first transistor will also be varying. The first transistor Q1 establishes the current to be mirrored. Additional transistors (in this case Q2 and Q3, as described in greater detail below) are added and connected to transistor Q1 such that the current flowing through the additional, current-mirroring transistors (Q2 and Q3) will be the same as the current flowing through the current-establishing transistor (Q1), assuming Q2 and Q3 are of the same size as Q1. It is, of course, important that all of the transistors used in a current-mirroring scheme are identical with one another, (e.g. the transistors has the same W and L and it is of the same type, HV or LV), a situation which is straightforward to implement with transistors on a single integrated circuit (IC).

If a different current (other than the current “I” which is established by Q1) is desired in a given branch of a current mirror, a number “n” of identical transistors (that is, the transistors has the same W and L and it is of the same type, HV or LV) are connected together (source to source, drain to drain, gate to gate) with one another to act in unison, each mirroring the established current. Thus, 3 transistors connected together can establish a current of 3*I, and “n” transistors connected with one another can establish a current of n*I.

The transistor Q2 is in the low threshold DET #1 portion of the clamper, and is connected via a resistor 456 having a resitance R to the positive port 452. Note the legend “15*I”. This means that there are 15 identical transistors (n=15) connected identically (source to source, drain to drain, gate to gate) with one another in this branch of the current mirror.

The transistor Q3 is in the high threshold DET #2 portion of the clamper; and is connected via a resistor 458 having a resitance R/2 to the positive port 452. Note the legend “5*I”. This means that there are 5 identical transistors (n=5) connected identically (source to source, drain to drain, gate to gate) with one another.

The lower threshold (VDET1_trip) DET#1 portion of the clamper has a higher resistance R and more identical transistors Q2 (15), and the higher threshold (VDET2_trip) DET#2 portion of the clamper has a lower resistance R/2 and fewer identical transistors Q3 (5).

The current mirror transistors (Q2 and Q3) are pulling DET1 and DET2 nodes down respectivly. The resistors R (456) and R12 (458) are pulling DET1 and DET2 nodes up respectivly. The ratios used in the design for Q2, Q3, R, R/2 were sized to give VDET1_trip to be lower than VDET2_trip.

Additionally, the high threshold DET #2 portion of the clamper is provided with a capacitor “C” across the sources and drains of the transistors Q3. Generally, the purpose of the capacitor is to support lower level ESD events, as explained later on.

With reference to the examples set forth in FIGS. 4A and 4B, it should be understood that the number of diodes is related to the voltages that it is desired to set the detection levels to. The resistances R and R/2 can be implemented as resistors, or transistors operating in a resistive mode, or any other active load. The resistance R/2 is intended as an example of a resistance which is smaller than the resistance R. The currents 5*I and 15*I are intended as examples of mirrored currents, and 15*I is an example of a current mirrored with the same or a different (and not necessarily larger) current than 5*I.

Details of Operation

The following is descriptive of the operation of the clamper 450 shown in FIG. 4B. V_{IN} refers to the voltage on the positive port 452 relative to the negative port 454.

While detector reference detects V_{IN}>V_{MIN},
the current source (Q1) starts to conduct I
the number of diodes defines V_{MIN}

Detector 1:
current source 15*I pulls node Det #1 down
R pulls note DEBT #1 up
when node DET1 reaches the trip point of the NAND, the clamping element (Q_{CE}) is driven
the detector stops driving the clamping element (Q_{CE}) when voltage falls below VDET1_trip or the RC time constant (defined by the pulling up C and R) has elapsed.

Detector 2:
current source 5*I pulls node Det #2 down
R/2 pulls node DET #2 up
when trip point of INV1 reached, the output of INV1 is togeling high, turning QL on (pulling the input of INV1 low) and the detection event is latched. The clamper is now clamping the ESD charge till fully discharged regardless of the the detector output, i.e. even if Vin is lower than VDET1_trip.

Detector 2:
smaller R (higher pull-up current)
smaller I (less pull-down current)
detection voltage VDET2_trip is higher than VDET1_trip

Latch inserted for full discharge after ESD zap
once voltage across the clampers' ports is low (but not necessarily low enough) the reference detector shuts down thus the DET1 node is driven to logical ‘1’
   this would have stopped the discharge
the latch keeps the clamper N-ch Q_{CE} “on”

Capacitor C is needed for the lower ESD zaps
where the reference detector current is too low
C Holds the DET#2 low and the clamper is locked due to combination of the fast ramping slope and the voltage level of the ESD event.

Tests and Simulations

In the provisional patent application, four diagrams are presented (at pages 9-12).

Regarding the diagram at page 9 of the provisional, entitled “Full Chip, Hot Insertion, Supp=4−5V/5V”, this simulation, run at Burn-In condition, verifies the behaviour of the clamper. The spec in this conditions for supply rise-time is 3 μsec. The simulations were run at several supply ramp-up such as 1 μsec/1.5 μsec/2 μsec for sensitivity verification. The upper graphs shows the full-chip current consumption under the relevant conditions The lower-graph shows the NCH clamper transistor's Q_{CE} gate voltage. The graphs proves the behaviour of the clamper under Burn-In conditions, for example the clamper is drawing some current when the supply is ramping up but the clamper is not locked, thus does not short the Burn-In supply.

Regarding the diagram at page 10 of the provisional, entitled “F.C. H.I. Supp=3.6V, 125° C.” (F.C. is an abbreviation for Full Chip, and H.I. is an abbreviation for Hot Insertion, 125° C. means 125 degrees Celsius), this simulation, run at maximum operating supply conditions, verifies the behaviour of the clamper under normal operation conditions. The spec in this conditions for supply rise-time is 1 μsec. The simulations were run at several supply slopes between 50 nSec to 300 nSec for sensitivity verification. The upper graphs shows the full-chip current consumption under the relevant conditions. The lower graph shows the NCH clamper transistor's Q_{CE} gate voltage. Both graphs proves the chip can handle supply ramp-up speeds of 100 nSec without locking or shorting the supply.

Regarding the diagram at page 11 of the provisional, entitled “ESD ZAP, lower ESD voltages, latch is latched”, the ESD Specs are 4 KV for the RBM, however the human can be charged into a lower voltage than the maximum specs. The design has to prove its ability to respond to lower ESD figures, namely locking the clamper and discharging the ESD energy totaly. These waveforms show that for an ESD event (as low as 100 V to as high as 2.1 KV), the circuit is locked and discharge the ESD energy completely.

Regarding the diagram at page 12 of the provisional, entitled “ESD ZAP, 4 KV, latch is latched”, this is the same situation as for slide 11, but for the maximum spec of 4 KV.

Page 13 of the provisional shows a detailed diagram of a full implementation of the clamp shown in FIG. 4B. As illustrated therein, the three series transistors in the right are VGS leaker, namely in cases the VGS of the Q_{CE} raise to levels which does not turn this transistor to its ON condition, the gate voltage will be discharged slowly to eliminate false clamping.

This situation might happen at the end of an ESD event and/or due to coupled noise to the gate of Q_{CE} In the practical circuit, the NAND is not fully implemented. Namely, DET2# locks the circuit but DET1# charge the gate of Q_{CE} which means the PCH portion of the NAND is conected to DET1# only while the NCH portion of the NAND is conencted to DET1# & DET2#

There has thus been shown and described a “smart” ESD clamper with dual-level operation. The clamper can distinguish between ESD event and normal operation voltage. The clamp circuitry locks in an ESD event. The clamper can be used for any ‘smart’ clamping requirement with dual-level definition (neither of which need be an ESD event).

One of the main advantages of the clamper is its ability to trim the VDET1_trip and VDET2_trip to be close to each-other within a wide dynamic range of operation of the clamper or another application.

There has thus been demonstrated a clamping scheme using dual sensing detection, which can sense and differentiate (in the extreme) between a high voltage level and fast (enough) slope (indicative of ESD), and low voltage level and slow slope (indicative of normal operation) and/or low voltage level and fast slope (indicative of hot insertion). It can also generate a locking scheme to ensure proper discharging only if the level is above high level and fast slope. It can also operate the clamping for a short time only if the level is below the high level but above the low level, and of sufficient (above a threshold) slope.

While a number of exemplary aspects and embodiments have been discussed above, those of skill in the art will recognize certain modifications, permutations, additions and sub-combinations thereof It is therefore intended that the following appended claims and claims hereafter introduced be interpreted to include all such modifications, permutations, additions and sub-combinations.

What is claimed is:

1. A method of ESD protection voltage clamping comprising:
using dual sensing detection, sensing and differentiating between (i) a voltage event exhibiting a relatively high voltage level and a relatively fast slope, (ii) a voltage event exhibiting a relatively low voltage level and a relatively slow slope, and (iii) a voltage event exhibiting a relatively low voltage level and a relatively fast slope.

2. The method of claim 1, wherein:
the relatively high voltage level and relatively fast slope voltage event is indicative of an ESD event; and
the relatively low voltage level and relatively slow slope voltage event is indicative of normal operation; and
the relatively low voltage level and relatively fast slope voltage event is indicative of hot insertion.

3. The method of claim 1, further comprising:
generating a locking scheme to ensure proper discharging only if the voltage level is above the high level and the fast slope.

4. The method of claim 1, further comprising:
operating the clamping for a short time only if the voltage level is below the high level but above the low level, and exceeds a threshold slope.

5. A method of performing voltage clamping comprising:
determining whether a voltage is above a pre-defined level; and
sensing voltage slope for voltages which are above the pre-defined level.

6. The method of claim 5, further comprising:
clamping voltage events when the voltage slope exceeds the pre-defined level.

7. The method of claim 5, wherein:
the voltage event having a slope exceeding the pre-defined level is an ESD event.

8. The method of claim 5, further comprising:
ignoring voltage events which are below the pre-defined level.

9. The method of claim 5, wherein voltage events below the pre-defined level include:
normal operating voltages, burn-in voltages and voltage ramps resulting from hot-insertion.

10. The method of claim 5, further comprising:
distinguishing between voltage events which exceed the pre-defined levels.

11. The method of claim 5, wherein:
a voltage event which exceeds the first pre-defined level as a voltage spike; and
a voltage event which exceeds the second pre-defined level as an electrostatic discharge (ESD).

12. The method of claim 11, wherein distinguishing between voltage events which exceed the pre-defined level comprises:
determining the magnitude and duration of the voltage event.

13. The method of claim 12, further comprising:
if the magnitude and duration of the voltage event is below a threshold level and below a threshold duration (spike), discharging the voltage event until the supply level is equal to the pre-defined sensing level; and
if the magnitude and duration of the voltage event is above a threshold level and above a threshold duration (ESD), discharging the voltage completely.

14. A method of ESD protection voltage clamping comprising:
providing an ESD circuit including at least one clamper;
in the clamper, determining whether a voltage is above a pre-defined level, sensing voltage slope for voltage events which are above the pre-defined level, and performing clamping when a slope or magnitude of the voltage event exceeds the pre-defined level.

15. The method of claim 14, wherein:
if the magnitude and duration of the voltage event is below a threshold level and below a threshold duration (spike), discharging the voltage event until the supply level is equal to the pre-defined sensing level; and
if the magnitude and duration of the voltage event is above a threshold level and above a threshold duration (ESD), discharging the voltage completely.

16. Clamper, comprising:
means for determining whether a voltage is above a pre-defined level;
means for sensing voltage slope for voltage events which are above the pre-defined level; and
means for discharging voltage events which are above the predefined level.

17. The clamper of claim 16, further comprising:
means for discharging the voltage event (spike), until the pre-defined level is reached.

18. The clamper of claim 16, further comprising:
means for discharging the voltage event (ESD), completely.
